(19) United States
(12) Patent Application Publication
(10) Pub. No.: US 2025/0196047 A1
(43) Pub. Date: Jun. 19, 2025

(54) METHOD AND SYSTEM FOR CAPTURING CARBON DIOXIDE

(71) Applicant: REVCOO, BRIGNAIS (FR)

(72) Inventors: Paul Jean Rolland TATON, CHEVINAY (FR); Hugo LUCAS, LYON (FR)

(21) Appl. No.: 18/832,586

(22) PCT Filed: Jan. 26, 2023
(86) PCT No.: PCT/FR2023/050103

§ 371 Date: Jul. 24, 2024

(30) Foreign Application Priority Data
Jan. 26, 2022 (FR) FR2200676

(51) Int. Cl. B01D 53/00; C01B 32/55; F25J 3/06

(52) U.S. Cl. CPC B01D 53/002; C01B 32/55; F25J 3/067; B01D 2257/504; F25J 2205/20

(57) ABSTRACT

The invention relates to a method for capturing carbon dioxide in which—at least one jet (2) of cooling fluid having a temperature below or equal to −78.5° C. is formed, said cooling fluid being chosen from the group formed of nitrogen, oxygen, air and mixtures thereof, —at least one jet (1a, 1b) of gas, referred to as gas to be treated, containing at least in part carbon dioxide, is formed—a step of solidifying the carbon dioxide is carried out in which said jet of cooling fluid and said jet of gas to be treated are sprayed in contact with one another, inside a chamber, said gas to be treated having a pressure greater than the pressure of said cooling fluid, —after said step of solidifying the carbon dioxide, carbon dioxide is recovered in the solid state. The invention also relates to a carbon dioxide capturing system suitable for implementing such a method.

### CROSS-REFERENCE TO RELATED APPLICATIONS

This application is a National Stage Application of PCT/FR2023/050103 filed Jan. 26, 2023, which claims priority from French Patent Application No. 2200676, filed on Jan. 26, 2022. The priority of said PCT and French Patent Application are claimed. Each of the prior mentioned applications is hereby incorporated by reference herein in its entirety.

### TECHNICAL FIELD OF THE INVENTION

The invention relates to the capture of carbon dioxide (CO₂) with a view to the storage and/or reuse thereof. The invention relates more particularly to a method and a device for capturing carbon dioxide.

### PRIOR ART

Carbon dioxide is one of the main greenhouse gases, in other words gases which, when present in the earth's atmosphere, contribute to global warming. Many human activities, in particular industrial activities, release gases comprising carbon dioxide.

Throughout the text, effluent means any fluid considered to be an emission from a facility. The latter may, for example, be a facility for manufacturing a compound such as lime, or a material or waste processing plant.

In order to limit these unwanted emissions into the atmosphere as much as possible, processes and devices for capturing (or trapping) carbon dioxide are known.

Document US2015/0260022 describes a method for enhanced oil recovery with the injection of solid carbon dioxide into the underground formation, said solid carbon dioxide being captured using several techniques. One such technique is based on the desublimation of carbon dioxide gas, in which a flow of super-chilled air is brought into contact with carbon dioxide. Although this method is interesting, it is not optimal.

Document US2018/0236397 describes a hydrocyclone for separating a gas such as carbon dioxide by desublimation using a cryogenic liquid making it possible to produce an enriched cryogenic liquid. The gas to be treated is introduced into the hydrocyclone in the opposite direction to the cryogenic liquid to cause turbulence allowing better mixing. The cryogenic liquid is not sprayed in the form of a jet, and the method is not optimal.

However, the devices known to date are not satisfactory with regard to the yields achievable and the energy costs that are necessary. In addition, the known devices have high investment costs and involve the use of polluting and/or non-renewable compounds used in the capture systems, such as chemical solvents and/or hydrocarbons.

In this regard, the invention aims to overcome the drawbacks of known methods and devices for capturing carbon dioxide.

### AIMS OF THE INVENTION

The invention aims to provide a method and a system for capturing carbon dioxide from a gas to be treated, which are adapted to be able to be implemented on an industrial scale while having reduced installation and implementation costs.

The invention also aims to propose a method and a device for capturing carbon dioxide making it possible not only to capture a significant proportion of the carbon dioxide contained in the effluent (indeed all or almost all of the carbon dioxide) but also to capture other pollutants that may be present in the gaseous effluent to be treated, such as volatile organic compounds (usually referred to as “VOCs”) or nitrogen oxides (usually referred to as “NOx”, that is to say in particular nitric oxide NO and nitrogen dioxide NO₂) or sulfur oxides (usually referred to as “SOx”, that is to say in particular sulfur dioxide SO₂ and sulfur trioxide SO₃).

### DISCLOSURE OF THE INVENTION

To this end, the invention relates to a method for capturing carbon dioxide in which:
at least one flow of fluid, referred to as cooling fluid, having a temperature of less than or equal to −78.5° C. (194.5 K) is provided, said cooling fluid being selected from the group made up of nitrogen, oxygen, air and mixtures thereof,
at least one flow of gas, referred to as gas to be treated, containing at least in part carbon dioxide, is provided,
at least onejet of said cooling fluid is formed and at least onejet of said gas to be treated is formed,
a step of solidification of the carbon dioxide is carried out in which said jet of cooling fluid and said jet of gas to be treated are sprayed in contact with one another, inside a chamber, said gas to be treated having a pressure greater than the pressure of said cooling fluid,
after said step of solidification of the carbon dioxide, carbon dioxide is recovered in the solid state.

The invention also relates to a system for capturing carbon dioxide comprising:
at least a first pipe in which at least one flow of fluid, referred to as cooling fluid, circulates, said cooling fluid having a temperature of less than or equal to −78.5° C. (194.5 K), said cooling fluid being selected from the group made up of nitrogen, oxygen, air and mixtures thereof,
at least a second pipe in which at least one flow of gas, referred to as gas to be treated and containing at least in part carbon dioxide, circulates,
at least one nozzle adapted to be able to form at least one jet of said cooling fluid and at least one jet of said gas to be treated,
a chamber adapted to allow the solidification of the carbon dioxide by spraying said jet of cooling fluid and said jet of gas to be treated in contact with one another, said gas to be treated having a pressure greater than the pressure of said cooling fluid, said first pipe and said second pipe being connected to said chamber,
a device for recovering carbon dioxide in the solid state.

The invention therefore also relates to a system for capturing carbon dioxide adapted to implement a method for capturing carbon dioxide according to the invention.

The invention differs from the prior art in that it proposes a method and a system in which the fluids are sprayed in the form of jets in a controlled manner, thus making it possible to optimize the capture of carbon dioxide.

A method and a system according to the invention make it possible to treat a wide variety of gaseous effluents (sometimes also called fumes or “condensable vapors”), including gaseous effluents comprising carbon dioxide (or other compounds to be captured), from very low concentrations (from 1% by volume in the flow of gas to be treated) up to very high concentrations (more than 90% by volume in the flow of gas to be treated).

To this end, the inventors found that placing a cooling fluid in accordance with the invention in direct contact with a gas to be treated, loaded with CO₂ to a greater or lesser extent, makes it possible to generate solid CO₂ via jets when the pressure of the sprayed gas to be treated is greater than the pressure of said sprayed cooling fluid.

Advantageously and according to the invention, nitrogen is selected as the cooling fluid.

Advantageously and according to the invention, said jet of cooling fluid and said jet of gas to be treated are sprayed in contact with one another such that said jet of cooling fluid and said jet of gas to be treated extend respectively in directions forming between them a non-zero angle of less than 90°, in particular a non-zero angle of less than 50°, before coming into contact with one another. Preferably, this angle is preferably less than 40°, more preferably less than 30° C., and even more preferably between 1° and 25°.

Advantageously and according to the invention, the system comprises at least one spray nozzle adapted to allow the ejection of at least two jets of fluid, namely at least a first jet, referred to as a circular jet, having a substantially circular cross section at the outlet of the nozzle, around at least a second substantially rectilinear jet, said second jet being arranged inside said first jet.

Thus, said spray nozzle is adapted to make it possible to form at least a first jet, referred to as a circular jet, having a substantially circular cross section at the outlet of the nozzle, around at least a second substantially rectilinear jet, said second jet being arranged inside said first jet, said first circular jet being said jet of gas to be treated and said second jet being said jet of cooling fluid.

In a preferred embodiment, the method for capturing carbon dioxide according to the invention comprises a step during which at least one jet of said cooling fluid is formed and at least one jet of said gas to be treated is formed using a spray nozzle. This means that the nozzle is capable of forming concomitantly and simultaneously two jets, one being a jet of the cooling fluid, the other being a jet of gas to be treated.

Preferably, the spray nozzle makes it possible to form a circular jet of gas to be treated, having a circular cross section at the outlet of the nozzle, and a second rectilinear jet of cooling fluid, said second jet being arranged inside said first jet.

In the present application, a clear distinction is made between a jet and a flow. A jet is by definition a spray of fluid which comes out with force, shooting out from the place where it is contained, through a small opening, typically as at the outlet of a nozzle. A flow is by definition a moving or flowing fluid corresponding to a more general movement of said fluid without the latter being sprayed.

It is also possible to use a nozzle comprising two internal ducts producing two jets of substantially rectilinear shape, or at least two single spray nozzles (each comprising just one internal duct), using at least one nozzle producing a jet of gas to be treated and at least one nozzle producing a jet of cooling fluid, the nozzles then being arranged relative to one another such that said jet of cooling fluid and said jet of gas to be treated extend respectively in directions forming between them a non-zero angle of less than 900 before coming into contact with one another.

Advantageously and according to the invention, the system comprises a flange for connection to said nozzle, said flange comprising two endpieces adapted to be able to be connected to said first pipe and to said second pipe.

Advantageously and according to the invention, the pressure of the flow of gas to be treated in the second pipe is greater than the pressure of the flow of cooling fluid in the first pipe.

Advantageously and according to the invention, said cooling fluid is used at a pressure of between 100 000 Pa and 500 000 Pa (at least at the start of the solidification step). The injection pressure of the cooling fluid is preferably greater than 150 000 Pa, and more preferably between 200 000 Pa and 400 000 Pa.

Likewise, advantageously and according to the invention, at least at the start of the solidification step, the cooling fluid has a temperature of less than or equal to −78.5° C. (194.5 K), in particular of the order of −196° C. (77 K).

Advantageously and according to the invention, said gas to be treated is used at a pressure of between 150 000 Pa and 800 000 Pa. Likewise, advantageously and according to the invention, at least at the start of the solidification step, the gas to be treated has a temperature of between 20° C. (293 K) and −120° C. (153 K).

Advantageously and according to the invention, said carbon dioxide solidification step is carried out by spraying said jet of cooling fluid and said jet of gas to be treated in contact with one another such that the ratio of the pressure of said gas to be treated to the pressure of said cooling fluid is between 1.5 and 3.5, in particular between 2 and 3.

The solid carbon dioxide formed in the chamber in which said at least one jet of cooling fluid and said at least one jet of gas to be treated are brought into contact may be recovered by any technique making it possible to separate solid particles from a gaseous mixture or a gas, in particular by centrifugation and/or by gravity which has an advantage for carbon dioxide given that it is known as a heavy compound. Some of the CO₂ may fall and be separated by gravity in a cyclone separator.

Advantageously and according to the invention, said system comprises at least one cyclone separator configured to allow said carbon dioxide to be recovered in the solid state. In particular, the cyclone separator is downstream and connected to the chamber in which said at least one jet of cooling fluid and said at least one jet of gas to be treated are brought into contact beforehand. Various cyclone separators may be used. The cyclone separator may for example have an inlet duct extending tangentially to a cylindrical portion of the cyclone separator. The inlet duct of the cyclone separator may also have a spiral shape, a helical shape, or an axial inlet duct (parallel to the longitudinal direction of the cyclone or to the axis of the cylindrical portion of the cyclone separator). In combination or as an alternative, each cyclone separator may also have a discharge hopper in the lower part making it possible to limit the passage of impurities and/or to limit the passage of the cooling fluid with solid carbon dioxide.

It is possible to provide several cyclone separators placed in parallel and/or in series. In the case where several cyclone separators are provided in parallel, this makes it possible to avoid installing a single cyclone separator of larger size in the case of large flow rates to be treated, thus allowing a partial shutdown of the facility in the event of maintenance on one or more of the cyclone separators. In the second case where several cyclone separators are provided in series, this allows greater efficiency in capturing solid carbon dioxide.

Advantageously and according to the invention, after said carbon dioxide solidification step, a step of separation by centrifugation is carried out so as to recover said carbon dioxide in the solid state.

Advantageously and according to the invention, said system comprises at least one condenser adapted to allow heat exchange to be carried out between said flow of gas to be treated and a flow, referred to as a recycled cooling flow, circulating from said chamber in a third pipe, so as to condense carbon dioxide at least partially.

Advantageously and according to the invention, prior to said carbon dioxide solidification step, a step referred to as a condensation step is carried out, in which heat exchange is carried out between said flow of gas to be treated and a flow, referred to as a recycled cooling flow, resulting from a previous step of solidification of the carbon dioxide, containing at least in part said cooling fluid selected from the group made up of nitrogen, oxygen, air and mixtures thereof, so as to condense carbon dioxide at least partially. Such an alternative embodiment of the method according to the invention is particularly advantageous in terms of energy efficiency but also with regard to the capture yield of the carbon dioxide present in the flow of gas to be treated entering the system according to the invention.

A method according to the invention thus makes it possible to capture part of the carbon dioxide on the one hand, in solid form (in particular in the form of flakes) and, on the other hand, in liquid form. Advantageously and according to the invention, between 60% and 90% by volume of carbon dioxide contained in the flow of gas to be treated is recovered during said condensation step and between 10% and 40% by volume of carbon dioxide is recovered during said carbon dioxide solidification step.

Advantageously and according to the invention, liquid nitrogen is selected as the cooling fluid.

Advantageously and according to the invention, said system comprises at least one compressor.

Advantageously and according to the invention, said system comprises at least one filter adapted to remove fine particles and/or hydrocarbon compounds (for example oil vapors from a compressor) from said flow of gas to be treated.

The invention also relates to a method and a system, characterized in combination by all or some of the features mentioned above or below.

### LIST OF FIGURES

Further aims, features and advantages of the invention will appear on reading the following description provided purely on a non-limiting basis and referring to the appended figures in which:

FIG. 1 is a schematic view illustrating the phenomenon of nucleation of solid carbon dioxide.

FIG. 2 is a schematic view of part of a system according to the invention.

FIG. 3 is a schematic view of a system according to the invention.

FIG. 4 is a schematic sectional view of a spray nozzle used in a method and a system according to the invention.

FIG. 5 is a rear perspective view of a flange that may be coupled to a spray nozzle of a system according to the invention.

FIG. 6 is a front perspective view of a flange that may be coupled to a spray nozzle of a system according to the invention.

FIG. 7 is a schematic sectional view of a flange coupled to a spray nozzle of a system according to the invention.

### DETAILED DESCRIPTION OF AN EMBODIMENT OF THE INVENTION

In the figures, scales and proportions are not strictly respected for the purposes of illustration and clarity.

In addition, identical, similar or analogous elements are designated by the same references in all the figures.

Throughout the text, the terms upstream and downstream are used with reference to the direction of circulation of the fluids within the system.

The pressure of the liquid nitrogen (between 1 bar and 5 bar) is always lower than the pressure of the gases injected (between 1.5 bar and 8 bar) such that the gases to be treated can effectively spray the jet of liquid nitrogen in the form of a full cone so as to generate a cloud of droplets. If the pressure of the gas to be treated is too much lower than the pressure of the jet of liquid nitrogen, then the jet cannot be broken up into droplets and the gases may end up bouncing off the jet of liquid nitrogen, thus failing to give rise to mixing and efficient heat exchange. This problem may make it difficult to evaporate the liquid nitrogen, resulting in a mixture of solid CO₂ and liquid nitrogen downstream in the system. Obtaining such a mixture leads to unnecessary overconsumption of liquid nitrogen and an additional step to separate solid CO₂ from liquid nitrogen.

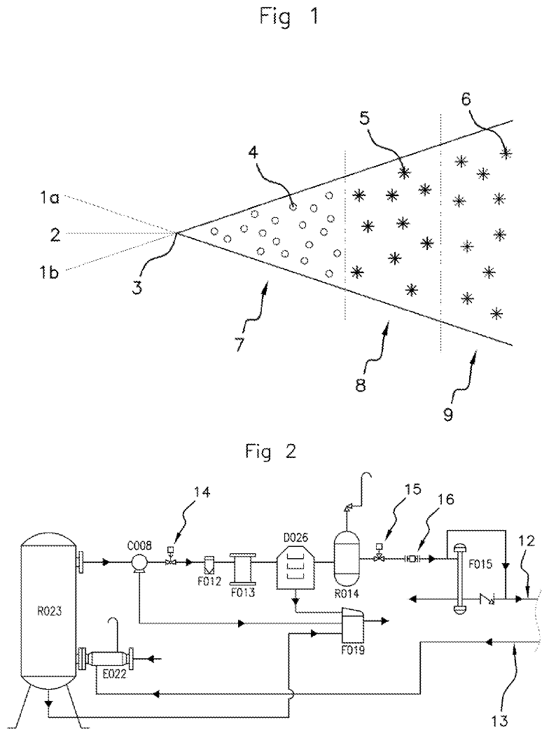

FIG. 1 depicts the phenomenon of nucleation that occurs following impact at a point 3 between a central jet 2 of cooling fluid and a circular jet 1 (lines 1a, 1b in FIG. 1) of gas to be treated. In a first phase 7 (spraying), droplets 4 of liquid cooling fluid are generated and will serve as a medium for the generation of solid CO₂ from the CO₂ present in the gas to be treated by nucleation during a second phase 8. CO₂ flakes need a medium so that they can be generated, this medium may be particles or droplets of variable sizes thus obtained when spraying a jet of liquid nitrogen, for example. During a second phase 8, the particles 5 are composed of droplets of cooling fluid and CO₂ flakes. In a third phase 9 (complete solidification), the particles 6 are only formed of CO₂ flakes.

The final temperatures in the sprayed cloud are between −78.5° C. (351.5 K) and −145° C. (128 K) depending on the quantity of CO₂ present in the gas to be treated. The lower the CO₂ concentration, the lower the temperatures must be to initiate the formation of solid CO₂. The formation of a cloud of liquid nitrogen droplets is ideal for obtaining such temperatures precisely and homogeneously thanks to regulation via the quantity of liquid nitrogen injected and the presence of droplets throughout the volume of the cloud. The advantage of using such a jet is therefore that it makes it possible to solidify almost all of the CO₂ present in the spray cloud and to precisely adapt the desired temperature by regulating the quantity of liquid nitrogen injected.

The droplets of cooling fluid, for example droplets of liquid nitrogen, formed are caused to evaporate on contact with the warmer gas to be treated, which provides a threefold advantage:
all of the cooling fluid used is evaporated by virtue of an adjustment of the quantity injected, which makes it possible to obtain only solid CO₂ (ice) downstream, the gaseous nitrogen or other cooling fluid being able to be easily separated and discharged;
full advantage is taken of the enthalpy of vaporization of the cooling fluid (for example nitrogen), that is to say the thermal energy necessary to evaporate the cooling fluid in addition to the cold provided by the latter and thus optimize heat transfers by injecting a sufficient quantity of cooling fluid so as to avoid obtaining a mixture of CO₂ ice and liquid nitrogen (or other cooling fluid) that is more difficult to use downstream;
the evaporation of the droplets also causes an increase in the pressure in the chamber S004, which makes it possible to increase the speed of the mixture entering the cyclone separator, thus promoting separation of the solids in the latter.

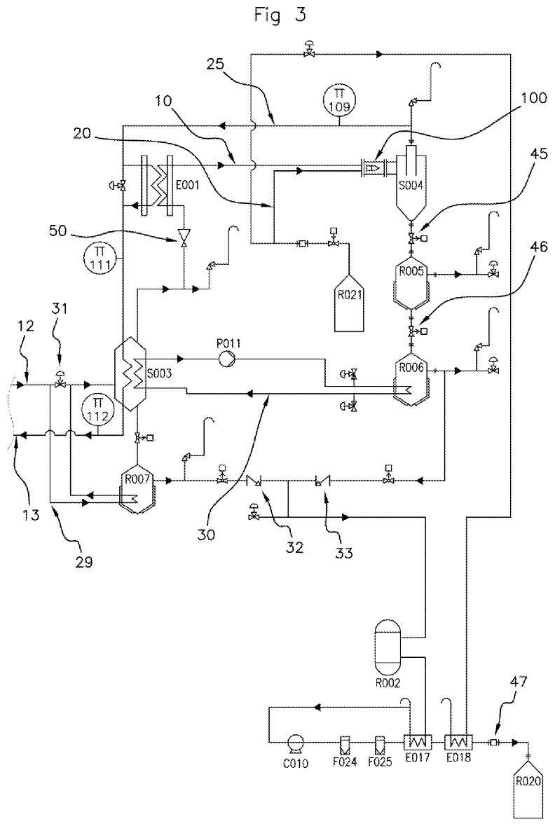

FIGS. 2 and 3 depict a schematic example of pipework and instrumentation of a system for capturing carbon dioxide according to the invention.

FIG. 2 depicts a preconditioning module of the system for capturing carbon dioxide according to the invention. This makes it possible to control and regulate certain characteristics of the flow of gas to be treated introduced into the system so as to optimize the efficiency of the method for capturing carbon dioxide. However, this preconditioning module is not essential, and the gas to be treated may be injected directly into the pipe 12 shown in FIG. 3. FIG. 3 depicts a capture module of the system according to the invention. In the embodiment described below, the preconditioning module and the capture module form part of the same capture system (being connected to one another by the pipes 12 and 13).

As can be seen in FIG. 2, the preconditioning module includes a buffer tank R023 for suction of fumes or effluents from a facility from which the gas to be treated containing carbon dioxide comes. An exchanger E022 is also provided upstream of this tank allowing precooling and drying of the gas to be treated. At the outlet of the buffer tank R023, the gas to be treated is compressed by a compressor C008 of the preconditioning module. The preconditioning module then comprises an actuator 14, a first coarse oil filter F012, a second activated carbon oil filter F013 (allowing refined filtration) and a dryer D026 connected to a condensate purifier F019. A buffer tank R014 for the compressed gas to be treated makes it possible to even out the desired flow rate of gas to be treated in the system. The preconditioning module lastly comprises a valve 15 (open during normal operation of the system and the method according to the invention), a flow meter 16 and a nitrogen separator F015 making it possible to remove any nitrogen present in the gas to be treated. The pipe 12 extends toward the capture module per se of the system (FIG. 3).

The system comprises a chamber S004 for solidification and separation of solid CO₂ connected at the inlet to a first pipe 20 and to a second pipe 10, the spray nozzle 100 being arranged at the inlet of the chamber S004. In this case, the chamber S004 for solidification and separation of solid CO₂ also comprises a cyclone separator making it possible to direct the solid to be separated into the lower part while allowing the fluid remaining in the upper part to be discharged (to a pipe 25 allowing the cooling fluid to be reused). The chamber S004 for solidification and separation of solid CO₂ is connected at the solid CO₂ output to a buffer tank R005 containing the solid CO₂ which is itself connected to a sublimation tank R006. Valves 45 and 46 are provided between these tanks. Note that in the case where the chamber S004 is a cyclone separator comprising a discharge hopper, the valve 45 is then optional. During the CO₂ capture method, it is preferred to close the valve 46 when the valve 45 is open and close the valve 45 before opening the valve 46.

Temperature sensors TT109, TT111 and TT112 are provided within the system for optimum control of the CO₂ capture parameters and to further optimize efficiency.

The pipe 25 directs the cooling fluid in a recycled cooling flow, containing at least in part cooling fluid selected from the group made up of nitrogen, oxygen, air and mixtures thereof, to a condenser S003 for condensing at least partially the carbon dioxide contained in the gas to be treated before it is injected into the chamber S004 via the pipe 10. The condensed carbon dioxide is collected in a tank R007 in which the liquid CO₂ recovered by means of the condenser S003 is evaporated.

A closed loop 29, including a valve 31, allowing heat exchange with the tank R007 may be provided.

The pipe 20 makes it possible to bring a cooling fluid selected from the group made up of nitrogen, oxygen, air and mixtures thereof (liquid nitrogen in the example described here) from a tank R021 in which the liquid nitrogen is maintained at a temperature of around −196° C. (77 K).

A plate exchanger E001 is provided before the inlet for the gas to be treated into the chamber S004, preceded by a pressure regulator 50 for the gas to be treated.

A closed loop 30 containing a coolant fluid (R508b® for example comprising 46% by weight of trifluoromethane and 54% by weight of hexafluoroethane) circulating with the aid of a pump P011 between the condenser S003 and the sublimation tank R006 may be provided. This loop 30 makes it possible to recover the cold from the solid CO₂ in the sublimation tank R006.

The condenser therefore makes it possible not only to recover the cold from the gas (treated fumes) leaving the cyclone separator but also the cold from the solid CO₂, through the loop 30 (see the two coils inside the condenser S003 in FIG. 3). It is also possible to add a third additional coil in the condenser S003 to circulate cooling fluid (liquid nitrogen for example) therein in order to provide extra cooling (not shown).

The capture system further comprises a CO₂ liquefaction module comprising a buffer tank R002 and a tank R020 containing liquid CO₂ (for example at a pressure of 20 bar (2 MPa) and at a temperature of −20° C. (253 K)). Non-return valves 32, 33 are provided. The liquefaction module also includes a compressor C010 for the captured CO₂, a coarse oil filter F024, an activated carbon oil filter F025 and plate exchangers E017 and E018.

The pressure regulator 50 for the gas to be treated and a pressure regulator for the cooling fluid integrated into the tank R021 make it possible to ensure that the gas to be treated has a pressure greater than the pressure of the cooling fluid during the carbon dioxide solidification step in which the jet of cooling fluid and the jet of gas to be treated are sprayed in contact with one another inside the chamber S004.

In an example of implementation of a method according to the invention, use is made of liquid nitrogen as cooling fluid, at a pressure of 200 000 Pa, and a gas to be treated at a pressure of 400 000 Pa. At the start of the solidification step, the cooling fluid has a temperature of less than or equal to −78.5° C. (194.5 K), in particular around −196° C. (77 K).

At the start of the solidification step (in the body of the spray nozzle), the gas to be treated preferably has a pressure of between 150 000 Pa and 800 000 Pa. Likewise, advantageously and according to the invention, at least at the start of the solidification step, the gas to be treated has a temperature of between 20° C. (293 K) and −120° C. (153 K).

Such a system and such a method make it possible to recover between 60% and 90% by volume of the carbon dioxide contained in the flow of gas to be treated during the condensation step and between 10% and 40% by volume of carbon dioxide during the carbon dioxide solidification step.

In the embodiment shown in FIGS. 2 and 3, in order to limit the complex handling of solid carbon dioxide and liquid carbon dioxide, these are respectively sublimated and evaporated before being packaged for storage. The enthalpy of sublimation of carbon dioxide is used to contribute to the capture, in liquid form, of carbon dioxide. The enthalpy of vaporization of the liquid carbon dioxide is used to precool and possibly generate at least partial liquefaction of the carbon dioxide in the gas to be treated before the step of separation of the liquid carbon dioxide.

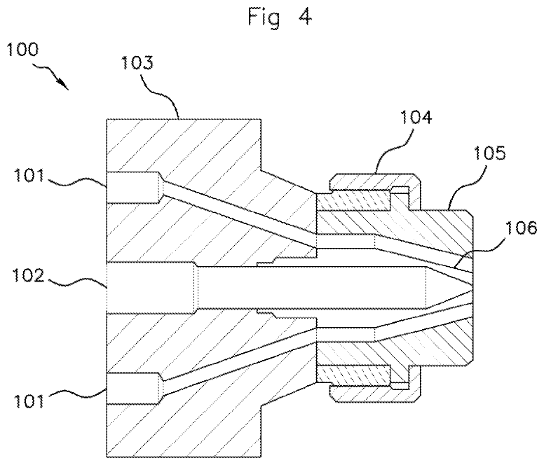

FIG. 4 depicts an example of a nozzle 100 allowing the formation of the jets 1a, 1b, 2 of gas to be treated and of cooling fluid. The nozzle 100 comprises two inlets 101 for gas to be treated on either side of a cooling fluid inlet 102 that is extended collinearly with the direction of the inlet 102 in the form of an internal duct. The nozzle 100 comprises a body 103 and a fastening nut 105. The two inlets 101 for gas to be treated extend toward two internal ducts formed within the body 103 and extending in the form of a distribution chamber 106 adapted to allow the formation of a rectilinear jet 2 of cooling fluid at the center of a jet referred to as circular, having a substantially circular cross section at the outlet of the nozzle (100). Such a configuration makes it possible to generate a full cone after impact between the circular jet of gas to be treated and the rectilinear jet of cooling fluid. The nozzle 100 may be made of a polymer material such as polytetrafluoroethylene (PTFE), or of a metal material (stainless steel for example).

There is nothing to prevent inversion of the gas to be treated and the cooling fluid such that the cooling fluid enters the two inlets 101 and the gas to be treated is injected into the inlet 102 of the nozzle 100, in such a way as to form a circular jet of cooling fluid and an inner jet of gas to be treated.

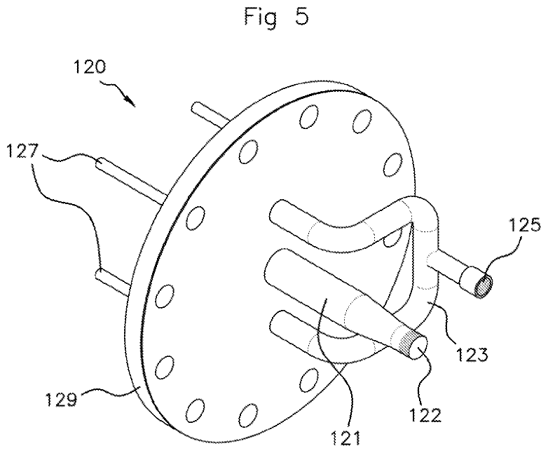

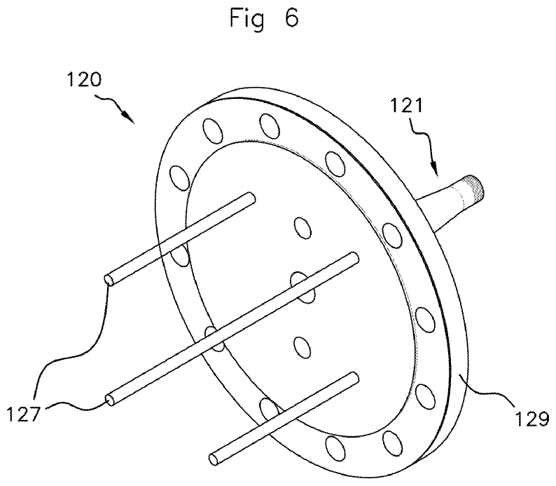

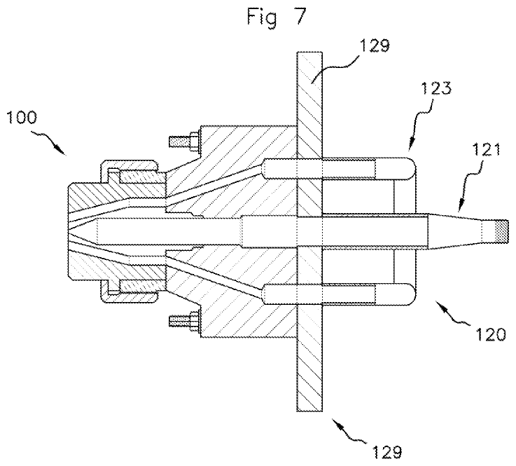

FIGS. 5, 6 and 7 show a flange 120 forming a support for the nozzle 100 and making it possible to connect the intake lines for the flow of gas to be treated and the cooling fluid to the inlet of the spray nozzle 100. Each flange 120 comprises a body 129 having the general shape of a disk from which there extend, from the same face of said disk, four positioning studs 127 adapted to be able to penetrate four bores of mating shape provided in the body of the nozzle 100 (FIG. 7). In the embodiment shown as an example, the flange is made of a metal material, for example stainless steel (304L or 316L steel for example). The body 129 of the flange 120 is pierced with three holes adapted to be positioned exactly opposite the inlets 101 and 102 for gas to be treated and for cooling fluid of the spray nozzle. On the opposite side of the body of the nozzle 100 to where the studs 127 are located, the flange 120 comprises a central connector 121 taking the form of a cylindrical duct the end of which has a concentric reduction and a male endpiece 122 adapted to be able to be connected to a cooling fluid intake pipe. The male endpiece 122 has, for example, a diameter of 10 mm. On the same side of the body of the nozzle 100, the flange 120 comprises a T-shaped connector 123 the end of which has a female endpiece 125 adapted to be able to be connected to an intake pipe for the gas to be treated. The flange has for example a diameter of around 12 to 20 mm and each inlet hole for the gas to be treated is spaced apart from a central inlet hole for the cooling fluid by a distance of around 60 mm.

1. A method for capturing carbon dioxide in which:
at least one flow of fluid, referred to as cooling fluid, having a temperature of less than or equal to −78.5° C. is provided, said cooling fluid being selected from the group made up of nitrogen, oxygen, air and mixtures thereof,
at least one flow of gas, referred to as gas to be treated, containing at least in part carbon dioxide, is provided,
at least one jet (2) of said cooling fluid is formed and at least one jet (Ta, Tb) of said gas to be treated is formed,
a step of solidification of the carbon dioxide is carried out in which said jet of cooling fluid and said jet of gas to be treated are sprayed in contact with one another, inside a chamber (S004), said gas to be treated having a pressure greater than the pressure of said cooling fluid,
after said step of solidification of the carbon dioxide, carbon dioxide is recovered in the solid state.

2. The method as claimed in claim 1, characterized in that at least onejet (2) of said cooling fluid is formed and at least onejet (1a, 1b) of said gas to be treated is formed using a spray nozzle.

3. The method as claimed in claim 1, characterized in that said jet of cooling fluid and said jet of gas to be treated are sprayed in contact with one another such that said jet of cooling fluid and said jet of gas to be treated extend respectively in directions forming between them a non-zero angle of less than 90°, in particular a non-zero angle of less than 50°, before coming into contact with one another.

4. The method as claimed in claim 1, wherein said cooling fluid is used at a pressure of between 100 000 Pa and 500 000 Pa.

5. The method as claimed in claim 1, wherein said gas to be treated is used at a pressure of between 150 000 Pa and 800 000 Pa.

6. The method as claimed in claim 1, wherein said carbon dioxide solidification step is carried out by spraying said jet of cooling fluid and said jet of gas to be treated in contact with one another such that the ratio of the pressure of said gas to be treated to the pressure of said cooling fluid is between 1.5 and 3.5, in particular between 2 and 3.

7. The method as claimed in claim 1, wherein, after said carbon dioxide solidification step, a step of separation by centrifugation is carried out so as to recover said carbon dioxide in the solid state.

8. The method as claimed in claim 1, wherein, prior to said carbon dioxide solidification step, a step referred to as a condensation step is carried out, in which heat exchange is carried out between said flow of gas to be treated and a flow, referred to as a recycled cooling flow, resulting from a previous step of solidification of the carbon dioxide, containing at least in part said cooling fluid selected from the group made up of nitrogen, oxygen, air and mixtures thereof, so as to condense carbon dioxide at least partially.

9. The method as claimed in claim 8, wherein between 60% and 90% by volume of carbon dioxide contained in the flow of gas to be treated is recovered during said condensation step and between 10% and 40% by volume of carbon dioxide is recovered during said carbon dioxide solidification step.

10. The method as claimed in claim 1, wherein liquid nitrogen is selected as the cooling fluid.

11. A system for capturing carbon dioxide comprising:
at least a first pipe (20) in which at least one flow of fluid, referred to as cooling fluid, circulates, said cooling fluid having a temperature of less than or equal to −78.5° C., said cooling fluid being selected from the group made up of nitrogen, oxygen, air and mixtures thereof,
at least a second pipe (10) in which at least one flow of gas, referred to as gas to be treated and containing at least in part carbon dioxide, circulates,
at least one nozzle (100) adapted to be able to form at least one jet of said cooling fluid and at least one jet of said gas to be treated,
a chamber (S004) adapted to allow the solidification of the carbon dioxide by spraying said jet of cooling fluid and said jet of gas to be treated in contact with one another, said gas to be treated having a pressure greater than the pressure of said cooling fluid, said first pipe (10) and said second pipe (20) being connected to said chamber (S004),
a device for recovering carbon dioxide in the solid state.

12. The system as claimed in claim 10, comprising a cyclone separator configured to allow said carbon dioxide to be recovered in the solid state.

13. The system as claimed in claim 10, comprising a condenser (S003) adapted to allow heat exchange to be carried out between said flow of gas to be treated and a flow, referred to as a recycled cooling flow, circulating from said chamber in a third pipe (25), so as to condense carbon dioxide at least partially.

14. The system as claimed in claim 10, wherein said spray nozzle (100) is adapted to make it possible to form at least a first jet, referred to as a circular jet (1a, 1b), having a substantially circular cross section at the outlet of the nozzle (100), around at least a second substantially rectilinear jet, said second jet (2) being arranged inside said first jet, said first circular jet being said jet of gas to be treated and said second jet being said jet of cooling fluid.

15. The system as claimed in claim 13, comprising a flange (120) for connection to said nozzle (100), said flange (120) comprising two endpieces (122, 125) adapted to be able to be connected to said first pipe and to said second pipe.
